(19) United States
(12) Patent Application Publication
(10) Pub. No.: US 2005/0015456 A1
(43) Pub. Date: Jan. 20, 2005

(54) System and method for eliminating unsolicited junk or spam electronic mail

(76) Inventor: John Robert Martinson JR., Atlanta, GA (US)

Correspondence Address: MYERS & KAPLAN, INTELLECTUAL PROPERTY LAW, L.L.C., 1899 POWERS FERRY ROAD, SUITE 310, ATLANTA, GA, 30339, US

(21) Appl. No.: 10/652,922

(22) Filed: Aug. 29, 2003

Related U.S. Application Data
(60) Provisional application No. 60/407,106, filed on Aug. 30, 2002.

(51) Int. Cl. G06F 15/16

(52) U.S. Cl. 709/207

(57) ABSTRACT

A system and method are described for eliminating unsolicited electronic mail, comprising a computer systems, a database of account identifiers and passwords, a database of blocked mail list addresses, an address book database containing known approved addresses, an override identifier code, and a program means for connecting to a mail server, retrieving messages, testing originating address for a match with addresses in a database of blocked mail addresses, testing originating address for a match with addresses in a database of acceptable addresses, testing message subject line for presence of an override identifier code or specific acceptable subject line word, updating blocked mail list with new rejected addresses, updating address book with new acceptable addresses from messages having override identifier code, deleting messages from senders on blocked list, and sending remainder of messages to a holding folder for aging and potential review and reading if desired by the user.

### CROSS-REFERENCES AND PRIORITY CLAIM TO RELATED APPLICATIONS

To the fullest extent permitted by law, this non-provisional patent application claims priority to, and the full benefit of, provisional application Ser. No. 60/407,106, filed Aug. 30, 2002, entitled “Device and Method for Eliminating Unsolicited Junk or Spam Electronic Mail”.

### TECHNICAL FIELD

The present invention relates generally to unsolicited electronic mail (email), typically advertisements, and more specifically known as junk mail or spam mail.

### BACKGROUND OF THE INVENTION

With the advent of computers, more and more mail transactions are taking place electronically. Almost all Internet users are assigned an address that is unique, much the same as a street address is assigned to the place of delivery of written or printed mail.

Historically, even mail delivered by postal carriers has increasingly contained unwanted advertising commonly known as junk mail. However, unlike email, printed junk mail is costly to the sender since it requires physical material to be sent, labor to send it, and postage to deliver it. Consequently, printed junk mail is limited in practicality to the sender and thus does not usually become overburdensome to the recipient.

As electronic mail, or email, has proliferated, there has been a boom in the sending of unsolicited email, very similar to the unsolicited mail that comes in printed form to homes and businesses. However, there is one key difference: Email has no cost of printing and the labor cost of adding additional addresses is so inconsequential that much email travels out unsolicited to any address the sender can find. The user may often find hundreds of unsolicited and unwanted email messages in a given day, within which the few messages that the user does desire to review are dispersed and hidden by the mass of other messages.

In addition to being called junk mail, unsolicited electronic mail, which is typically sent out on a mass basis to mailing lists of email users, has gained the name of “spam mail”, “spam email” or just plain “spam”. These terms are generally utilized throughout the computer industry to describe unsolicited matter. The process of sending out messages to many addresses is known as “spamming”, and is frowned upon by the majority of computer users.

Electronic mail messages comprise an address, typically a subject line and, of course, the body of the message itself. By using these parts of a message it is possible to screen or filter mail coming to the user.

Previously, different methods have been utilized to attempt to filter the electronic mail that comes to the addressee. One such method is for the user to select return addresses from which he or she wishes to receive mail. By this method, one tells the software client (program that is being utilized for obtaining the email) being utilized that only messages from those specific addresses are suitable, and that all others should be returned or sent directly to whatever vehicle is utilized for deletion of unwanted or no longer needed messages. This method suffers from the limitation that there might be valid messages coming in from addresses that the user has failed to include in his address listing.

A different method utilizes restrictions based on the source internet provider's address, which is an address fundamental to all the users residing on that source's hosting service. Since it is possible that one user on the hosting service might create and send spam mail to other users elsewhere, the reaction of recipients could result in the restriction and refusal of mail coming from that source address. However, if a recipient decides to globally restrict email from such a source provider, desired messages could be prevented from reaching the recipient. For instance, many other legitimate users may well reside on that same source and, as a result, their mail would not get through to the addressee.

Another method utilized is to restrict specific email addresses, rather than a complete source restriction. However, this method has also proven to be disadvantageous. Because email addresses are so easily obtainable, coupled with the fact that spammers are aware of this method of restriction, spammers will often just simply create new email addresses to ensure successful delivery to the recipient. As a result, recipients must constantly add new email addresses to their restricted list.

An additional method utilized for eliminating unsolicited email is that of matching the subject line, or portions thereof, against a selected set of words typical of those found in unsolicited messages. For example, messages with sexual content often have the word ‘sex’ within the subject line to attract the recipient's interest. Accordingly, by matching the subject line with a database of exclusionary words, including ‘sex’, messages of this type may be filtered out.

On the other side of the coin, it is often desirable for emails from a given source domain, such as a company address, to be permitted to flow through to the recipient. Also, when messages have been previously accepted from a particular domain from several users at that domain, who potentially have opted-in (“Opt-in”) for communication by email, it may be desirable to permit all messages from that domain to pass through to the recipient. An example of two Opt-in emails from the same domain would be art.williams@xyz.com and beth.jones@xyz.com. For such purposes, it may be desirable to allow all mail originating from xyz.com to progress through to the user. This would be particularly applicable where the user works for a company using the xyz.com domain. One might carry this further to allow all addresses with jones@xyz.com, such as beth.jones@xyz.com or jim.jones@xyz.com. Such use of partial addresses to encompass global permission for certain domains is described as global partial addressing.

Therefore, it is readily apparent that there is a need for a system and method for processing email in such a fashion that unsolicited junk mail or spam mail is disposed of with no effort on the part of the user, while desired mail is retained without rejection. Because most spammers will not typically expend additional effort, it is particularly important to this system and method that the unknown sender is required to take affirmative action in order to send the email.

### BRIEF SUMMARY OF THE INVENTION

Briefly described, in a preferred embodiment, the present invention, MAIL WIPER™, overcomes the above-mentioned disadvantages, and meets the recognized need by providing a system and method for removal and elimination of unsolicited junk email or spam email, wherein email from known, acceptable electronic mail addresses is permitted through and email from known, unacceptable addresses is deleted, while email from unknown electronic mail addresses is initially placed in a separate folder. At the same time, an autoreply message is sent to the originator that will allow them to automatically place a code in their subject line that will allow the message to process through on the next attempt.

According to its major aspects and broadly stated, the present invention in its preferred form is an email software program operating on a computer in conjunction with an email client program residing on the computer, wherein the present invention eliminates unsolicited electronic mail, while at the same time permitting mail from desired addresses to pass through to the user.

More specifically, the present invention is a software program that takes control of the email client, providing several rules of operation therefor, and sorts mail into groups that are either desirable or unsolicited. Further, the program allows for those senders with a valid reason for sending mail, and thus those who will take the time to review the returned message, an opportunity to resend their message with a unique code allowing it to pass through the system to the end user.

By using a computer with its associated memory, storage, operating system and input/output components, coupled with a software program, the user may retrieve electronic mail from desired sources while ignoring mail from undesired sources.

A feature and advantage of the present invention is its ability to selectively remove unsolicited email so that the recipient is not required to take any action to remove said unsolicited email.

A feature and advantage of the present invention is its ability to operate transparently, such that the user does not perceive its operation.

A feature and advantage of the present invention is its ability to allow desired mail to proceed through to the recipient.

A feature and advantage of the present invention is its ability to allow Opt-in email, that is email from a given source domain address, but which has different email addresses associated with it, to proceed through to the user in spite of varying source addresses for such mail.

A feature and advantage of the present invention is its ability to provide valid email senders with a means to send email through to the recipient.

A feature and advantage of the present invention is its ability to perform its function and then exit, leaving the transformed email client to perform its email retrieval with obtrusive spam mail being blocked.

A feature and advantage of the present invention is its ability to block spam or junk email.

A feature and advantage of the present invention is its ability to avoid filtering out desired or potentially desired mail.

A feature and advantage of the present invention is that once an email address or a global partial address is deemed acceptable, its inclusion in a list of acceptable addresses or global partial addresses will automatically remove the address from the blocked mail list.

A feature and advantage of the present invention is its ability to be easily installed and configured.

These and other features and advantages of the present invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Alternate Embodiments with reference to the accompanying drawing figures FIG. 1 and FIG. 2, in which like reference numerals denote similar structure and refer to like elements throughout, and in which:

FIG. 1 depicts a flowchart of the main program method of the present invention; and

FIG. 2 is a flowchart of the continuation and exit program method of the present invention.

### DETAILED DESCRIPTION OF THE PREFERRED AND SELECTED ALTERNATE EMBODIMENTS

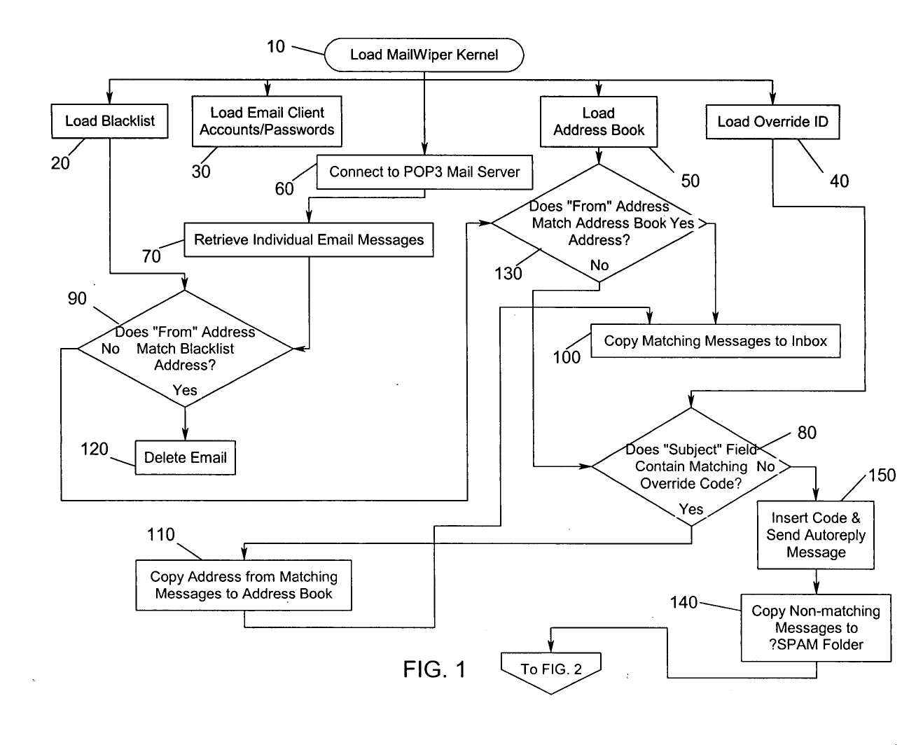

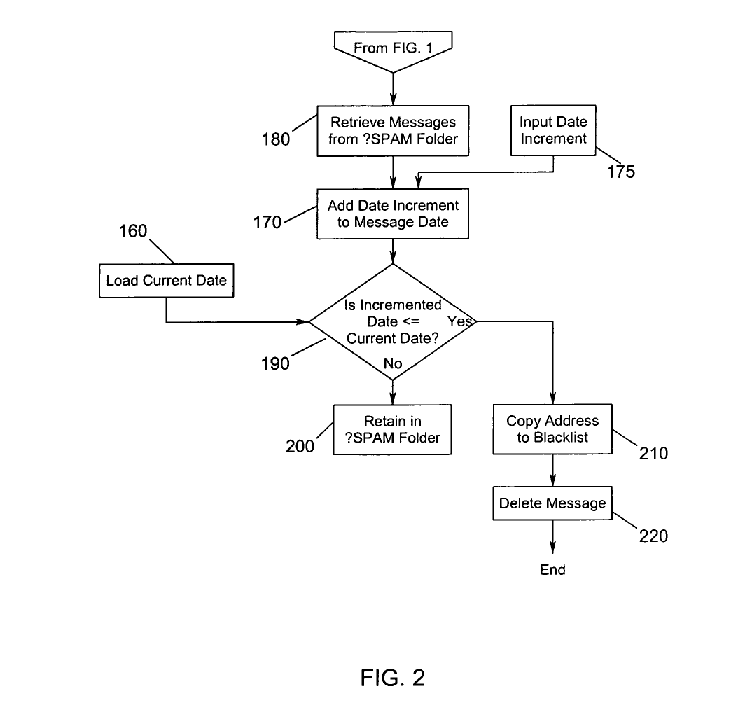

In describing the preferred embodiments of the present invention, as illustrated in FIGS. 1-2, and alternate embodiments, specific terminology is employed for the sake of clarity. The invention, however, is not intended to be limited to the specific terminology so selected, and it is to be understood that each specific element includes all technical equivalents that operate in a similar manner to accomplish similar functions.

Furthermore, the order of events depicted in FIGS. 1-2 is dependent upon the email client utilized, and specific events may take place in different order.

In the course of operation when a message is received, it may come from a known address, either one that is acceptable, or one that has been determined to be unacceptable and which is listed in a blocked mail list database 20 or “Blacklist”.

Acceptable known addresses, wherein a known address may be an electronic mail (email) address, a partial email address and/or a unique, yet recognizable, word group of alphanumeric characters or punctuation, will come from an address book 50, residing within an email client program, such as for exemplary purposes only, MICROSOFT® Outlook Express™ or MICROSOFT® Outlook, and/or from a database entered by a user of the present invention. A database of acceptable subject line codes and/or words will also be entered by the user, wherein the subject line codes and/or will contain alphanumeric characters or punctuation.

In an alternate to the preferred embodiment, a global or partial global address could additionally be tested to determine if it has been accepted previously. Once a global address or partial global address has been accepted, it will permit other addresses having the same global address to pass through. Additionally, allowing permission for global addresses to pass through to the recipient could trigger the removal of all addresses having the same global or partial global address to be removed from blocked mail list database 20.

When an electronic message is received, it is preferably tested 90 by the program to determine whether the originating, or “from” address, is known as part of the blocked mail list database 20, in which case, it will preferably be deleted. If the address is not on the blocked mail list, it will preferably be tested 80 to determine whether the subject line contains an override code identifier 40. If the code is present, the sender's address will preferably be placed 110 in the user's address book 50 and allowed through to the user 100. If the code is not present, the message will preferably be tested 130 to see if it has a known address, wherein a known address may be an electronic mail (email) address, a partial email address and/or a unique, yet recognizable, word group of alphanumeric characters or punctuation, corresponding to an entry in the address book 50. If so, the message will preferably be sent through to the reader 100. If there is no match to these latter two tests, the message will preferably be presumed to be an unsolicited email, will preferably generate an auto reply 150 with override code identifier 40 and instructions therein to preferably allow the original email message to be received without deletion, and the original message will preferably be placed in a folder, for exemplary purposes known as the ?SPAM folder 140, from where it will preferably eventually be deleted 220. The period of time the message will be permitted to remain before deletion 160 will preferably be entered by the user during program set up.

Prior to routine use of the present invention, the user is preferably required to input certain parameters for the program to draw on during future operations. Among these are preferably the input of a selected override identifier code 40, a waiting period for aging of messages 175, an address book listing of addresses that are acceptable 50 and a list of email client account number/password combinations 30. These latter two items will preferably reside within the user's email client and will preferably only need to have their location identified to the program. In addition, to the extent that the user can ascertain them, a list of blocked mail addresses 20 is preferably input.

The first of these items, the override code 40, will preferably be utilized by the program to insert into the text of autoreply messages 80. The autoreply preferably will allow the original sender, on close inspection, to automatically insert a code in the “subject” line, which code will preferably allow the message to pass through to the originally intended addressee.

The waiting period of, for exemplary purposes only, thirty days, will preferably allow messages to remain in the ?SPAM folder for optional viewing by the user. After the time period 175 set by the user expires, the message will preferably be deleted and the address will be automatically added to blacklist 210.

The address book will be selected from the email client being utilized. Representative email clients, included for exemplary purposes only and not limited thereby, are MICROSOFT® Outlook™, Microsoft Outlook Express™ (both trademarks of MICROSOFT® Corporation), Lotus Organizer™ (trademark of IBM Corporation), Netscape™ (trademark of Netscape Communications Corporation) and Eudora™ (trademark of Qualcomm Incorporated).

As the program initiates for the first time, the user will be required to enter an override identifier code 40 and an aging period 175 of time for messages that are unidentified. This is to permit the user to retain messages that might have been sent by a desired source that is not yet listed in the address book 50. In addition, the set up program will request an initial list of unacceptable addresses for inclusion in the blocked mail list 20, and the location of the address book 50 containing addresses that are permitted to send mail to the user.

Referring now to FIG. 1, the present invention in its preferred embodiment is a process that preferably commences by loading kernel program 10. Kernel program 10 then preferably loads into memory address book database 50, blocked mail list database 20, and account number/password combinations 30 for email clients that will be utilized to access and to retrieve mail. Kernel program 10 also preferably loads the previously-saved override identifier code 40 into memory. Next, kernel program 10 preferably connects to POP3 mail server 60, preferably sends account number/password doublet 30, and preferably retrieves email messages 70 from the requested source.

Retrieved email messages 70 are preferably then compared to two databases, blocked mail list and address book, while retrieved email message subject lines are preferably compared to see if override identifier code 40 is present. If there is a match between blocked mail list address 20 and message address, message will preferably be deleted 120; otherwise, message will preferably be tested 130 for presence of known “From” address contained within address book database 50. If a match is found between message “From” address and known address in address book database 50, message will preferably be sent directly to inbox 100. If there is no match, message will preferably be tested 80 for identifier code 40 in its subject line. If identifier code 40 is present in subject line, then address of the sender will preferably be added to address book database 50 and message will preferably be sent through to the inbox 100. If the subject line does not contain specific override identifier code 40, then message is preferably sent to ?SPAM folder 140.

Finally, kernel program 10 will preferably send an autoreply message 150 to all originating addresses that have not passed the previous tests. This step will be carried out preferably on entry of message to ?SPAM folder 140. Following this, kernel program 10 will preferably process its exit routine, which is depicted in FIG. 2, and described more fully hereinafter.

Referring to FIG. 2, kernel program 10 will preferably send automated messages 150 out to all senders of new messages contained in ?SPAM folder 140. A body portion of the automated message preferably contains an identifier code 40 and instructions to insert the code into the subject line of the to-be-resent message in order to preferably allow message to be processed through to the user's inbox 100 upon resending. Once autoreply message 150 has been sent, a flag may be set to indicate that an autoreply message 150 has been generated and sent for that message. In an alternate embodiment, the entry of message to the ?SPAM folder 140 will trigger sending of autoreply message, thus obviating the need for a flag to be set.

Next, kernel program 10 will preferably load current date 160 and test whether message date, as adjusted 170 by the user-selected waiting period 175, is the same as or older than current date 160. If adjusted message date is the same or older than current date 160, message address will preferably be added 210 to blocked mail list file 20 and message itself will be deleted 220. If the age of adjusted message 170 is newer than current date 160 for user-selected waiting period, message will preferably be retained in ?SPAM folder 200.

In another alternate embodiment, portions of existing email client programs may be utilized to conduct some steps of the present invention. In this fashion, the kernel program accesses the rule-making portion for the filters of an electronic mail client, such as, for exemplary purposes only, MICROSOFT® Outlook Express™, and therein adds the list of acceptable email addresses, a list of partial email addresses that are acceptable, and the user input override identifier code. Having done this, the filter is assigned to the appropriate folder, such that any messages not meeting the required criteria are sent to the ?SPAM folder, and those that do meet the criteria pass through to the inbox. Alternate email clients, such as Outlook™97, Outlook™2000, Outlook™XP, Outlook™ Mac, AOL™, Netscape™, and Eudora™ may function in a slightly different fashion, but the concept would remain the same. Through this utilization, the email client itself would filter the messages. Kernel program 10 operates to transform the addresses from the address book to the filter rule of the email client. The rules would be modified by kernel program 10 upon each receipt of new messages to reflect new message sources that are to be permitted.

In yet another alternate embodiment, the email client may also be utilized for handling the database of unacceptable addresses, such that the kernel program will include in the rules all unacceptable addresses. In this fashion, using for exemplary purposes only, Microsoft Outlook Express™, each time a new address meets the criteria for unacceptability, it will be added to the list of blocked senders within the email client. This will then be updated by the kernel program and maintained as a list that the user may edit, if they so choose.

In a further alternate embodiment, a global address or a global partial address may be tested in coordination with specific words from the subject line of retrieved messages.

In a contemplated alternative embodiment, an autoreply email message could be sent to any originally-sent message 70 that is not within blocked mail list database 20 or within acceptable addresses from the address book database 50, wherein autoreply email message advises original sender to visit a linked webpage via a hyperlink. Original sender then clicks on hyperlink in autoreply email message, wherein original sender is then transferred to linked webpage.

On linked webpage are located instructions, an entry form, original sender's email address pre-entered on entry form and a graphic image of alphanumeric characters and/or punctuation marks. Original sender is directed via instructions to type image viewed into entry form and to submit via clicking a submit button. Entry form will be transferred to MAIL WIPER™ user, wherein MAIL WIPER™ user will have the ability to approve pre-entered email address by accepting entry form.

Once original sender's email address has been approved, the next send/receive operation of MAIL WIPER™ user's electronic mail client will cause original sender's address to be entered into database of acceptable addresses in the address book 50 and original email from original sender 70 will be deposited in MAIL WIPER™ user's inbox 100 automatically.

Since original sender's email address is now in acceptable address book database 50, original sender will not have to go through approval process again.

In a modification of the above alternate embodiment, it is envisioned that upon submitting entry form, original sender's email address may be automatically added to acceptable address book database 50 and original sender's original message is deposited in MAIL WIPER™ user's inbox 100, all without intervention required by MAIL WIPER™ user.

The foregoing description and drawings comprise illustrative preferred and alternate embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing the steps of the method in a certain order does not necessarily constitute any limitation on the order of the steps of the method. Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation. Accordingly, the present invention is not limited to the specific embodiments illustrated herein, but is limited only by the following claims.

1. A system for eliminating unsolicited electronic mail comprising:
a. at least one computer, including memory, storage, input and output components;
b. means for connecting said at least one computer to an electronic mail server;
c. at least one database comprising unacceptable addresses;
d. at least one address book database comprising known approved addresses;
e. at least one override identifier code; and
f. operational software.

2. The system of claim 1, wherein said means for connecting comprises a connection to the Internet.

3. The system of claim 1, wherein said operational software further comprises means for retrieving messages, wherein said retrieved messages comprise an originating address, a subject line and a body.

4. The system of claim 3, wherein said means for retrieving messages comprises an electronic mail client.

5. The system of claim 3, wherein said operational software locates said originating address of a message selected from said retrieved messages.

6. The system of claim 5, wherein said operational software further comprises means for rejecting said retrieved messages, wherein said means for rejecting rejects and deletes any message having said originating address identical to an address in said at least one database of unacceptable addresses or not containing codes in said subject line identical to specific codes in a database of acceptable subject line codes.

7. The system of claim 6, wherein said operational software updates said at least one database of unacceptable addresses by addition thereto of said originating address of said rejected message.

8. The system of claim 5, wherein said operational software further accepts said retrieved messages having said originating address identical to an address in said at least one database of known approved addresses, and forwards said accepted messages to an electronic mail client's inbox.

9. The system of claim 4, wherein said operational software locates said at least one override identifier code in said subject line of a message selected from any of said retrieved messages.

10. The system of claim 9, wherein said originating addresses of said retrieved messages having said at least one override identifier code in said subject line are added to said at least one address book database of acceptable addresses and said retrieved message having said at least one override identifier code is sent to the inbox of said electronic mail client.

11. The system of claim 3, wherein said retrieved messages having said originating addresses that do not match an address in either said at least one database of unacceptable addresses or said at least one database of known approved addresses are sent to a holding folder.

12. The system of claim 3, further comprising:
a reply message, comprising at least one override identifier code inserted in the body of said reply message; and
instructions inserted in said body of said reply message instructing a recipient thereof to include said at least one override identifier code in the subject line of a return message.

13. The system of claim 3, further comprising:
a current date; and
a message date with incremental number of days added thereto, wherein said message date is tested relative to said current date and, if said incremented message date is earlier than said current date, said retrieved messages having said incremented message date earlier than said current date are added to said at least one database of unacceptable addresses and deleted.

14. The system of claim 1, wherein said address book database further comprises global addresses, global partial addresses and specific subject line words.

15. A method for eliminating unsolicited electronic mail comprising the steps of:
a. providing an override identifier code;
b. receiving electronic mail messages, said electronic mail messages comprising an originating address, a subject line and a body;
c. testing said subject line of said electronic mail messages to determine the presence of said override identifier code; and
d. permitting said electronic mail messages having said override identifier code present to be reviewed by an electronic mail recipient.

16. The method of claim 15, further comprising the steps of:
e. comparing said originating address to the addresses in an address book; and
f. if said electronic mail message has said originating address the same as an address in said address book, accepting said electronic mail message.

17. The method of claim 15, further comprising the steps of:
e. comparing said originating address to the addresses in a list of unacceptable addresses; and
f. if said electronic mail message has said originating address the same as an address in said list of unacceptable addresses, deleting said electronic mail message.

18. The method of claim 15, further comprising the steps of:
e. comparing said originating address to the addresses in a list of unacceptable addresses and the addresses in an address book;
f. if said originating address is not the same as either an address in said list of unacceptable addresses or an address in said address book, forwarding said electronic mail message to a holding folder.

19. The method of claim 18, further comprising the steps of:
g. aging messages in said holding folder for a pre-selected period; and
h. deleting messages in said holding folder after said pre-selected period.

20. A method for eliminating unsolicited electronic mail comprising the steps of:
a. providing a database of acceptable addresses and a database of acceptable subject line codes;
b. providing a database of unacceptable addresses;
c. providing a database of accounts with passwords;
d. providing an override identifier code for insertion into a message subject line;
e. connecting to a mail server;
f. retrieving electronic mail messages from said mail server, said electronic mail messages comprising an originating address, a subject line and a body;
g. comparing said originating address for a match with addresses in said database of unacceptable addresses;
h. deleting messages having an originating address matching an address in said database of unacceptable addresses;
i. comparing said originating address for a match with addresses in said database of acceptable addresses;
j. forwarding to an inbox, messages having an originating address matching an address in said database of acceptable addresses;
k. testing the subject line of remaining messages to determine the presence of said override identifier code or said database of acceptable subject line codes;
l. sending an autoresponse message containing said override identifier code in the message body to all addresses for said remaining messages lacking said identifier code in their subject line;
m. sending to a holding folder said remaining messages lacking said identifier code in their subject line;
n. testing the age of electronic mail in said holding folder;
o. adding overage source message addresses to the database of unacceptable addresses; and
p. deleting overage messages,
whereby unsolicited messages are automatically removed from the need for observation and review by the addressee.

21. The method of claim 20, replacing said step g) with step:
g′) testing the subject line for a specific code and comparing said specific code with said database of acceptable subject line codes.

22. An electronic mail handling system for eliminating unsolicited electronic mail comprising:
a. computer means for processing data, including central processing unit, operating system, memory, storage, and input/output devices;
b. connecting means for connecting computer means to a mail server;
c. electronic mail client;
d. database of acceptable addresses and a database of acceptable subject line codes;
e. database of unacceptable addresses;
f. override identifier code;
g. software program means for transforming electronic mail messages, comprising
i. first means for retrieving a database of acceptable addresses from said email client;
ii. second means for retrieving a database of unacceptable addresses;
iii. third means for retrieving a database of accounts with passwords;
iv. fourth means for retrieving an override identifier code for insertion into a message subject line;
v. fifth means for retrieving electronic mail messages from said mail server, said electronic mail messages further comprising an originating address, a subject line and a message;
vi. sixth means for comparing said originating address for a match with addresses in said database of unacceptable addresses;
vii. seventh means for deleting messages having an originating address matching an address in said database of unacceptable addresses;
viii. eighth means for comparing said originating address for a match with addresses in said database of acceptable addresses;
ix. ninth means for forwarding to an inbox, messages having an originating address matching an address in said database of acceptable addresses;
x. tenth means for testing the subject line of remaining messages to determine the presence of said override identifier code;
xi. eleventh means for sending an autoresponse message containing said override identifier code in the message body to all addresses for messages lacking said identifier code in their subject line;
xii. twelfth means for sending to a holding folder messages lacking said identifier code in their subject line;
xiii. thirteenth means for testing the age of electronic mail in said folder;
xiv. fourteenth means for adding overage message addresses to the database of unacceptable addresses; and
xv. fifteenth means for deleting overage messages,
whereby unsolicited messages are automatically removed from the need for observation and review by the addressee.

23. The electronic mail handling system of claim 22, further comprising means for testing for presence of both at least one approved global address or partial global address, and at least one word matching a code in said database of acceptable subject line codes.

24. A method of accepting unsolicited electronic mail messages comprising the steps of:
a) providing an electronic mail client program having an inbox and an operating program having an address book of acceptable addresses;
b) sending an autoreply message to a sender of said unsolicited electronic mail original message, wherein said autoreply message comprises instructions to sender, and a hyperlink to a web page, wherein said instructions:
i. direct sender to click on said hyperlink,
ii. direct sender to view said web page directed thereby, wherein said web page contains said unsolicited message sender's electronic mail address pre-entered thereon,
iii. direct sender to enter alphanumeric or punctuation characters viewed in an image on said web page, and
vi. direct sender to submit said entered characters as a response;
c) permitting an electronic mail recipient to accept or reject said submitted response, wherein if said response is accepted, said unsolicited electronic message sender's pre-entered electronic mail address is entered into said address book of acceptable addresses; and
d) sending said unsolicited electronic mail sender's original message to said electronic mail recipient's inbox.

25. The method of claim 24, wherein step c) is replaced by step:
c′) entering said unsolicited electronic message sender's pre-entered electronic mail address into an electronic mail recipient's address book of acceptable addresses.
